(19) United States
(12) Patent Application Publication
(10) Pub. No.: US 2011/0081522 A1
(43) Pub. Date: Apr. 7, 2011

(54) THREE-DIMENSIONAL FOAMING TYPE TRANSFER PAPER WITH ENHANCED DURABILITY AND METHOD FOR MANUFACTURING THE SAME

(75) Inventor: Jae Woon Kim, Jangsan-myeon (KR)

(73) Assignee: 3d TRANSFER PAPER DEVELOPMENT CO., LTD., Seoul (KR)

(21) Appl. No.: 12/672,070

(22) PCT Filed: Aug. 1, 2008
(86) PCT No.: PCT/KR08/04481

§ 371 Date: Feb. 3, 2010

(30) Foreign Application Priority Data
Aug. 3, 2007 (KR) 10-2007-0078100

(51) Int. Cl. B41M 5/382; B05D 1/36; B41M 5/26

(52) U.S. Cl. 428/159; 427/258

(57) ABSTRACT

A three-dimensional foaming type transfer paper with an enhanced durability and a method for manufacturing the same is disclosed. The transfer paper includes a releasing agent layer having a releasing sheet and formed on the releasing sheet using transparent silicon; a fluorine coating layer formed on the releasing agent layer; a silicon rubber layer formed only on a portion of the fluorine coating layer on which printing is to be performed, through a silk screen process; a first fluoride polyester layer formed on the silicon rubber layer; a printed layer formed on the first fluoride polyester layer using ink; a second fluoride polyester layer formed on the printed layer; a first foaming layer formed partially on the second fluoride polyester layer; a second foaming layer formed on the first foaming layer; and a thermal adhesive resin layer formed on the second foaming layer.

### TECHNICAL FIELD

The present invention relates to a three-dimensional foaming type transfer paper with an enhanced durability and a method for manufacturing the same, and more particularly, to a three-dimensional foaming type transfer paper capable of preventing a transferred pattern from being crack during washing and improving a feeling of solidity, and a method for manufacturing the same.

### BACKGROUND ART

In general, characters, letters, symbols, etc., which have various patterns and colors, are transferred to clothes including dresses, casual wears, children's wears, and the likes, so that design as trademarks, marks, emblem, product pictures, character pictures, works, etc., can be represented to provide points to the clothes, designate membership in the case of clubs or groups or obtain advertising effect in the case of enterprises.

The transfer of characters, letters or symbols to clothes is implemented in a manner such that transfer papers having characters, letters or symbols are manufactured and then the characters, letters or symbols are transferred to the clothes from the transfer papers.

A conventional transfer paper is composed of a release sheet, a first transparent layer, a printed layer, a second transparent layer, and an adhesive layer. One surface of the release sheet is coated with a coating layer so that the release sheet has a smooth surface for ensuring easy release of the release sheet. After the release sheet is prepared in this way, the first transparent layer is laminated on the release sheet. The printed layer, which is formed by printing characters, letters or symbols, is laminated on the first transparent layer. The second transparent layer is laminated on the printed layer, and the adhesive layer is laminated on the second transparent layer, by which the manufacture of the conventional transfer paper is completed.

In the conventional transparent paper constructed as described above, by bringing the upper surface of the transfer paper into contact with the outer surface of clothes and then pressing the transfer paper using an iron, etc. having a predetermined temperature, the characters, letters or symbols can be transferred from the transfer paper to the clothes.

However, the conventional transparent paper has a drawback in that it does not render any feeling of solidity because characters, letters, marks, etc., which are two-dimensionally transferred to clothes, so that letters and marks can not be variously represented.

In order to overcome the above problems, a transfer paper and method for manufacturing the same is disclosed KOREA Patent Application No. 10-1999-50620.

In the above KOREA Patent, the transfer paper comprises a releasing sheet, a first transparency layer formed on an upper surface of the releasing sheet, a printed layer formed on an upper surface of the first transparency layer, a second transparency layer formed on upper surface of the printed layer, a foaming layer formed on between the second transparency layer and a adhesive resin layer through a heating process, and the adhesive resin layer formed on an upper surface of the foaming layer.

However, the above transfer paper according to the KOREA Patent Application No. 10-1999-50620 has problems. That is, the characters of the transfer paper have not the feeling of solidity.

For example, a portion of a nose, a mouth, eyes, a forehead, a cheek, etc. for a face character, which is transferred to the clothes, is equally formed in height. In addition, the character is cracked in the washing.

### DISCLOSURE OF INVENTION

### Technical Problem

Accordingly, the present invention has been made in an effort to solve the problems occurring in the related art, and an object of the present invention is to provide a three-dimensional foaming type transfer paper capable of preventing a transferred pattern from being a crack during a washing and improving a feeling of solidity, and a method for manufacturing the same.

### Technical Solution

In order to achieve the above object, according to one aspect of the present invention, there is provided a method for manufacturing a three-dimensional foaming type transfer paper, comprising the steps of forming a releasing agent layer on an upper surface of a release paper using transparent silicon; forming a fluorine coating layer on an upper surface of the releasing agent layer; forming a silicon rubber layer only on a portion of an upper surface of the fluorine coating layer on which printing is to be performed, through a silk screen process; forming a first fluoride polyester layer on an upper surface of the silicon rubber layer; forming a printed layer on an upper surface of the first fluoride polyester layer using ink; forming a second fluoride polyester layer on an upper surface of the printed layer; forming partially a first foaming layer on an upper surface of the second fluoride polyester layer; forming a second foaming layer on an upper surface of the first foaming layer; forming a white background layer on an entire surface of a resultant structure using a white pigment; and forming a thermal adhesive resin layer on an entire surface of the white background layer.

In order to achieve the above object, according to another aspect of the present invention, there is provided a functional and three-dimensional foaming type transfer paper comprising a releasing agent layer having a releasing sheet and formed on an upper surface of the releasing sheet using transparent silicon; a fluorine coating layer formed on an upper surface of the releasing agent layer; a silicon rubber layer formed only on a portion of an upper surface of the fluorine coating layer on which printing is to be performed, through a silk screen process; a first fluoride polyester layer formed on an upper surface of the silicon rubber layer; a printed layer formed on an upper surface of the first fluoride polyester layer using ink; a second fluoride polyester layer formed on an upper surface of the printed layer; a first foaming layer formed partially on an upper surface of the second fluoride polyester layer; a second foaming layer formed on an upper surface of the first foaming layer; and a thermal adhesive resin layer formed on an entire upper surface of the second foaming layer.

According to another aspect of the present invention, a white background layer is additionally formed on an entire lower surface of the thermal adhesive resin layer using a white pigment.

According to another aspect of the present invention, the white background layer is narrowly formed than the thermal adhesive resin layer.

### Advantageous Effects

In the three-dimensional foaming type transfer paper with enhanced durability and the method for manufacturing the same according to the present invention, due to the presence of a first forming layer and a second forming layer formed in a transfer paper, the characters are three-dimensionally formed.

In addition, the characters are prevented from the crack by means of the releasing sheet and silicon rubber layer during the washing.

Specifically, due to the fact that the presence of the fluorine coating layer and the first and second fluoride polyester layers in the transfer paper, the each layers of the characters are firmly adhered, the durability of the characters formed in the transfer paper can be enhanced.

### BRIEF DESCRIPTION OF THE DRAWINGS

The above objects, and other features and advantages of the present invention will become more apparent after a reading of the following detailed description taken in conjunction with the drawings, in which:

FIG. 1 is a flow chart illustrating a method for manufacturing a three-dimensional foaming type transfer paper in accordance with one embodiment of the present invention;

FIG. 2 is a perspective view illustrating a three-dimensional foaming type transfer paper in accordance with another embodiment of the present invention;

FIG. 3 is a sectional view of the transfer paper shown in FIG. 2;

FIGS. 4 through 7 are views illustrating a process for transferring a pattern from the transfer paper to clothes; and

FIGS. 8 and 9 are respectively a perspective view and a sectional view illustrating the state in which the pattern is transferred to clothes and foamed.

### BEST MODE FOR CARRYING OUT THE INVENTION

Reference will now be made in greater detail to preferred embodiments of the invention, examples of which are illustrated in the accompanying drawings. Wherever possible, the same reference numerals will be used throughout the drawings and the description to refer to the same or like parts.

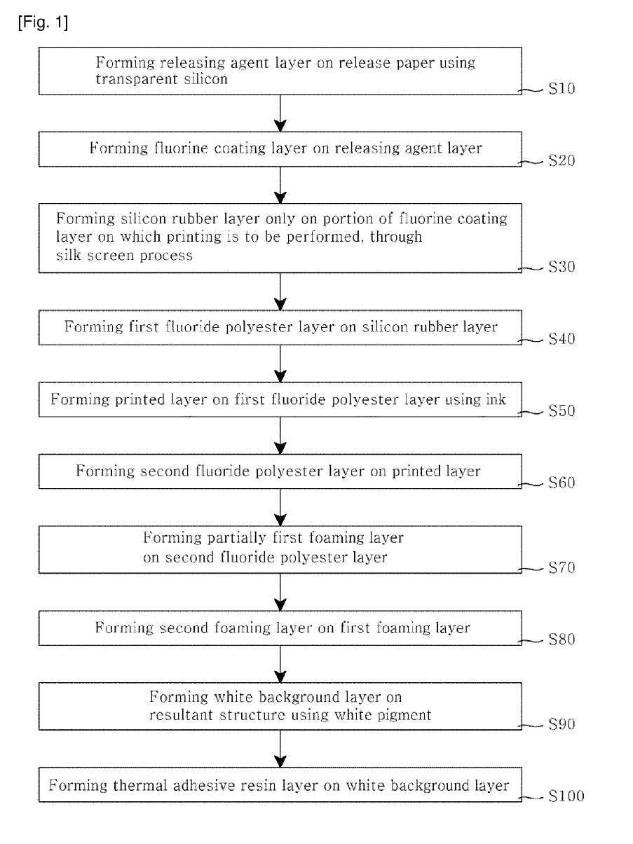

FIG. 1 is a flow chart illustrating a method for manufacturing a three-dimensional foaming type transfer paper in accordance with one embodiment of the present invention.

Referring to FIG. 1, a transparent paper 10 according to the present invention is manufactured through a procedure for sequentially forming layers from a releasing agent layer 110, which is exposed to the outside when a pattern is transferred to a piece of clothes 200 and is then foamed, to a thermal adhesive resin layer 19, which adheres to the piece of clothes.

In detail, a releasing sheet 100, which is to be removed after a pattern is transferred from the transfer paper 10 to the clothes and is then foamed, is first prepared. The releasing agent layer 110 is formed on the upper surface of the releasing sheet 100 using transparent silicon (S10). When the pattern is transferred and foamed and the releasing sheet 100 is removed, the releasing agent layer 110 formed of transparent silicon is not removed with the releasing sheet 100 and functions to cover and protect the upper surface of the transferred and foamed pattern.

After the first step S10, a fluorine coating layer 11 is formed on the upper surface of the releasing agent layer 110 (S20). The fluorine coating layer 11 formed in the second step S20 functions to ensure firm adhesion of the releasing agent layer 110 and a silicon rubber layer 12 which will be formed in a third step S30.

Then, the silicon rubber layer 12 is formed on the upper surface of the fluorine coating layer 11 formed in the second step S20. It is preferred that the silicon rubber layer 12 be formed only on a portion of the upper surface of the fluorine coating layer 11 on which printing is to be performed, through a silk screen process.

After the third step S30, a first fluoride polyester layer 13 is formed on the upper surface of the silicon rubber layer 12 (S40). The first fluoride polyester layer 13 functions to ensure that ink soaks well when performing offset printing or silk screen printing on the silicon rubber layer 12.

After the fourth step S40, a printed layer 14 which is printed with a certain character, letter or figure, is formed on the upper surface of the first fluoride polyester layer 13 through offset printing or silk screen printing (S50).

After the fifth step S50, a second fluoride polyester layer 15 is formed on the upper surface of the printed layer 14 (S60). The second fluoride polyester layer 15 functions to allow the printed layer 14 and a first foaming layer 16 which will be subsequently formed, to easily adhere to each other.

After the sixth step S60, the first foaming layer 16 is formed partially on the upper surface of the second fluoride polyester layer 15 (S70). Since the first foaming layer 16 contains a foaming agent, it can be foamed through heating.

After the seventh step S70, a second foaming layer 17 is formed on the upper surface of the first foaming layer 16 (S80). Similar to the first foaming layer 16, since the second foaming layer 17 contains a foaming agent, it can be foamed through heating.

After the step S80, a white background layer 18 is formed on the entire surface of the resultant structure using a white pigment (S90). The white background layer 18 is formed using the white pigment so that a background can be created to clearly present the colors of a design to be printed on the piece of clothes.

After the functional layer forming step S90, a thermal adhesive resin layer 19 is formed over the entire upper surface of the white background layer 18 (S100).

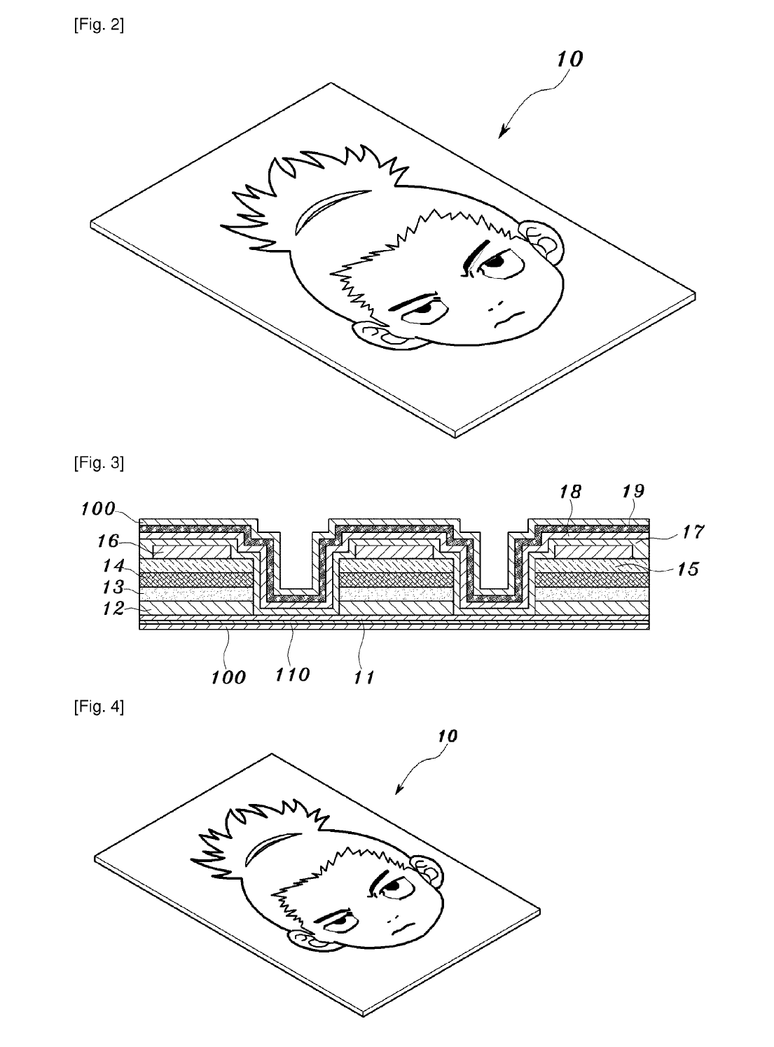

The construction of the transfer paper 10 according to the present invention manufactured as described above will be described below with reference to FIGS. 2 and 3.

FIG. 2 is a perspective view illustrating the functional and three-dimensional foaming type transfer paper 10 in accordance with another embodiment of the present invention, and FIG. 3 is a sectional view of the transfer paper 10 shown in FIG. 2.

Referring to FIGS. 2 and 3, the transfer paper 10 according to the present invention is composed of several layers. That is to say, the transfer paper 10 includes a releasing agent layer 110 having a releasing sheet 100 and formed on the upper surface of the releasing sheet 100 using transparent silicon; a fluorine coating layer 11 formed on the upper surface of the releasing agent layer 110; a silicon rubber layer 12 formed only on a portion of the upper surface of the fluorine coating layer 11 on which printing is to be performed, through a silk screen process; a first fluoride polyester layer 13 formed on the upper surface of the silicon rubber layer 12; a printed layer 14 formed on the upper surface of the first fluoride polyester layer 13 using ink; a second fluoride polyester layer 15 formed on the upper surface of the printed layer 14; a first foaming layer 16 formed partially on the upper surface of the second fluoride polyester layer 15; a second foaming layer 17 formed on the upper surface of the first foaming layer 16; a white background layer 18 formed on the entire upper surface of the second foaming layer 17 using a white pigment; a functional layer 55 formed on the upper surface of the white background layer 18 by spreading functional powder; and a thermal adhesive resin layer 19 formed on the upper surface of the functional layer 55. Because the releasing sheet 100, the fluorine coating layer 11, the silicon rubber layer 12, the first and second fluoride polyester layers 13 and 15, and the first and second foaming layers 16 and 17 are known in the art, detailed descriptions thereof will be omitted herein.

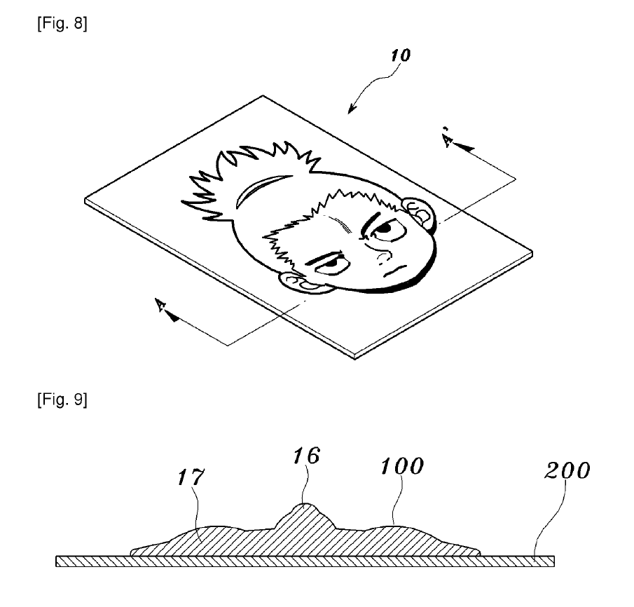

A process for transferring a pattern from the transfer paper to a piece of clothes will be described below with reference to FIGS. 4 through 9.

The transfer paper 10 according to the present invention is placed on a piece of clothes such that the releasing sheet 100 formed on the lower end of the transfer paper 10 faces upward and the thermal adhesive resin layer 19 comes into contact with the piece of clothes.

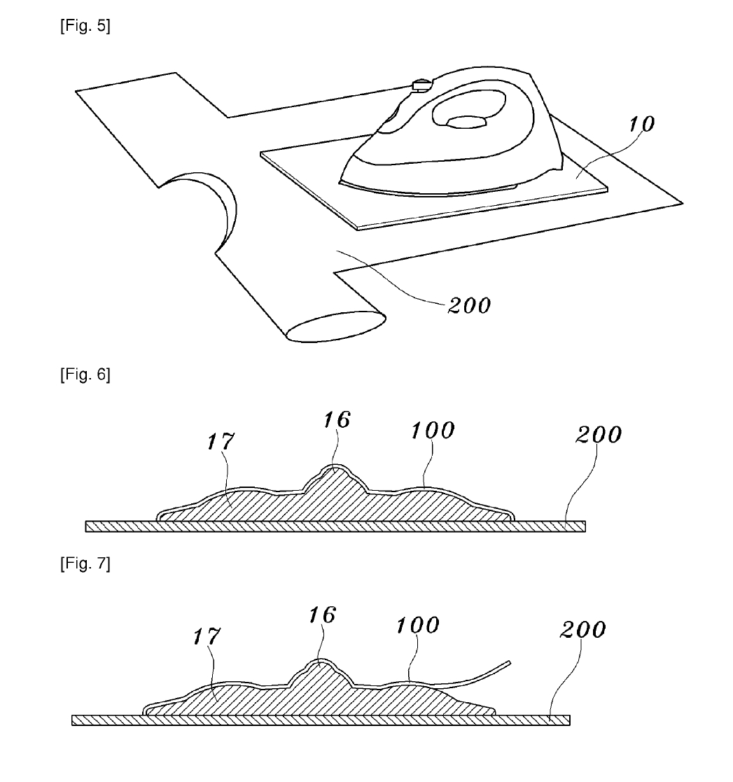

In this state, by applying heat using an iron, etc., the thermal adhesive resin layer 19 is melted and adheres to the piece of clothes, and the first and second foaming layers 16 and 17 are foamed and are increased in volume. In the case of transferring a face as shown in FIGS. 6a and 6b, the first foaming layer 17 forms the base of the entire face, and the second foaming layer 16 forms a protruding portion such as a nose, so that the nose protrudes out of the base of the entire face.

The releasing agent layer 110, which is formed using transparent silicon, covers the entire pattern of the face from the outside to prevent cracks from occurring by application of external force. In addition, the silicon rubber layer 12 formed as an intermediate layer also prevents cracks from occurring. As is well known in the art, if silicon is baked, it is unwilling to be thermally melted and has substantial elastic returning force.

The fluorine coating layer 11 and the first and second fluoride polyester layers 13 and 15 function to ensure easy coupling of layers having different physical properties.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A method for manufacturing a three-dimensional foaming type transfer paper with an enhanced durability, comprising the steps of:
forming a releasing agent layer on an upper surface of a release paper using transparent silicon;
forming a fluorine coating layer on an upper surface of the releasing agent layer;
forming a silicon rubber layer only on a portion of an upper surface of the fluorine coating layer on which printing is to be performed, through a silk screen process;
forming a first fluoride polyester layer on an upper surface of the silicon rubber layer;
forming a printed layer on an upper surface of the first fluoride polyester layer using ink;
forming a second fluoride polyester layer on an upper surface of the printed layer;
forming partially a first foaming layer on an upper surface of the second fluoride polyester layer;
forming a second foaming layer on an upper surface of the first foaming layer;
forming a white background layer on an entire surface of a resultant structure using a white pigment; and
forming a thermal adhesive resin layer on an entire surface of the white background layer.

2. A three-dimensional foaming type transfer paper with an enhanced durability comprising:
a releasing agent layer having a releasing sheet and formed on an upper surface of the releasing sheet using transparent silicon;
a fluorine coating layer formed on an upper surface of the releasing agent layer;
a silicon rubber layer formed only on a portion of an upper surface of the fluorine coating layer on which printing is to be performed, through a silk screen process;
a first fluoride polyester layer formed on an upper surface of the silicon rubber layer;
a printed layer formed on an upper surface of the first fluoride polyester layer using ink;
a second fluoride polyester layer formed on an upper surface of the printed layer;
a first foaming layer formed partially on an upper surface of the second fluoride polyester layer;
a second foaming layer formed on an upper surface of the first foaming layer; and
a thermal adhesive resin layer formed on an entire upper surface of the second foaming layer.

3. The transfer paper as set forth in claim 2, wherein a white background layer is additionally formed on an entire lower surface of the thermal adhesive resin layer using a white pigment.

4. The transfer paper as set forth in claim 3, wherein the white background layer is narrowly formed than the thermal adhesive resin layer.
